(19) United States
(12) Patent Application Publication
(10) Pub. No.: US 2018/0148302 A1
(43) Pub. Date: May 31, 2018

(54) REMOTE CONTROL DEVICE

(71) Applicant: TADANO LTD., Kagawa (JP)

(72) Inventor: Hiroyuki HAYASHI, Kagawa (JP)

(73) Assignee: TADANO LTD., Kagawa (JP)

(21) Appl. No.: 15/574,733

(22) PCT Filed: Sep. 27, 2016
(86) PCT No.: PCT/JP2016/078335

§ 371 Date: Nov. 16, 2017

(30) Foreign Application Priority Data
Oct. 1, 2015 (JP) 2015-196269

(51) Int. Cl. B66C 13/40

(52) U.S. Cl. CPC B66C 13/40; B66C 23/42; B66C 2700/088

(57) ABSTRACT

There is provided a small remote control device for an actuator of a mobile crane that can be operated by one hand and with which it is easy to perform operations specific to large cranes, the remote control device being provided with: a device body; a plurality of selectors which are each disposed on an operation surface, and which set the operating direction of the actuator selected by movement in a first direction or a section direction from a neutral position to a forward direction or a reverse direction; and a trigger which moves the actuator selected by the selectors in the forward direction or the reverse direction according to the operation amount. Of the plurality of selectors, the two selectors, which are most frequently used in a work preparation step for the mobile crane are disposed adjacent to the vicinity of the center of the operation surface.

### TECHNICAL FIELD

The present invention relates to a remote control apparatus for actuators of a mobile crane.

### BACKGROUND ART

Conventionally, a remote control apparatus for remotely controlling actuators of a mobile crane has been proposed. As an operator's cab of a mobile crane has a large number of levers, even though it is attempted to reproduce the lever layout at a remote control apparatus as it is, the size of the apparatus is increased so that the apparatus is not suitable for carrying. Meanwhile, in the case of a vehicle-mounting type crane, the number of operation inputs is relatively small. Accordingly, a small-sized remote control apparatus that is operable by one hand is realized.

Besides, PTL 1 discloses a transmitter for remotely controlling a crane having an initial mode and an operation mode, for example. In such a transmitter for remotely controlling a crane, the initial mode includes a setting mode for a user, a setting mode for service, and a setting mode for a manufacturer.

### CITATION LIST

### Patent Literature

### PTL 1

### Japanese Patent No. 4611481

### SUMMARY OF INVENTION

### Technical Problem

As described above, in a conventional remote control apparatus, there is a problem in that it is not easy to perform operation by a limited number of operation sections, and that the number of operation inputs is insufficient for work preparation (for example, extension and housing of a jib and operation of four outriggers) specific to a large crane such as a rough terrain crane or an all-terrain crane.

Therefore, an object of the present invention is to provide a small-sized remote control apparatus that is operable by one hand and in which work preparation specific to a large crane can be performed easily.

### Solution to Problem

In order to achieve the aforementioned object, a remote control apparatus of the present invention is a remote control apparatus for actuators of a mobile crane. The apparatus includes an apparatus body having a grip to be gripped by a hand and an operation surface for operating the actuators, a plurality of selection sections for selecting an actuator, the selection sections each being disposed on the operation surface, the selection sections each setting a motion direction of the selected actuator to be a forward direction or a backward direction according to a movement of the selection section from a neutral position to a first direction or a second direction, and a trigger section disposed near the grip, the trigger section allowing the actuator selected by the selection section to operate in the forward direction or the backward direction according to the operation amount. Among the selection sections, two selection sections that are most frequently used in a work preparation step of the mobile crane are disposed adjacently near center of the operation surface.

### Advantageous Effects of Invention

As described above, a remote control apparatus of the present invention includes an apparatus body, a plurality of selection sections each disposed on an operation surface, the selection sections each setting a motion direction of a selected actuator to be a forward direction or a backward direction according to a movement of the selection section from a neutral position to a first direction or a second direction, and a trigger section that allows the actuator selected by the selection section to operate in the forward direction or the backward direction according to the operation amount. Among the selection sections, two selection sections that are most frequently used in the work preparation step of the mobile crane are disposed adjacently near the center of the operation surface. As the present invention has such a configuration, it is possible to provide a remote control apparatus that is operable by one hand and in which work preparation specific to a large crane is easily performed.

### BRIEF DESCRIPTION OF DRAWINGS

FIG. 1 is a side view of a mobile crane;

FIG. 2 is a block diagram of a control system of Embodiment 1;

FIG. 3 is a front view of a remote control apparatus;

FIG. 4 is a side view of the remote control apparatus;

FIG. 5 is an enlarged front view illustrating an enlarged operation surface of the remote control apparatus;

FIG. 6 illustrates an initial screen of a mode select;

FIG. 7 illustrates a screen of a crane mode;

FIG. 8A illustrates a jack-up confirmation screen in a jib mounting/dismounting step mode, and FIG. 8B illustrates a jib mounting/dismounting screen in the jib mounting/dismounting step mode;

FIG. 9 illustrates a screen of an outrigger extending/housing step mode; and

FIGS. 10A and 10B illustrate screens in which a selection section selected in the outrigger extending/housing step mode is highlighted, in which FIG. 10A illustrates a step of extending a right-side outrigger, and FIG. 10B illustrates a step of extending a front-side outrigger.

### DESCRIPTION OF EMBODIMENTS

Hereinafter, embodiments of the present invention will be described with reference to the accompanying drawings. The constituents elements described in the embodiments provided below are illustrated as examples, and do not limit the technical scope of the present invention.

### Embodiment 1

(Configuration)

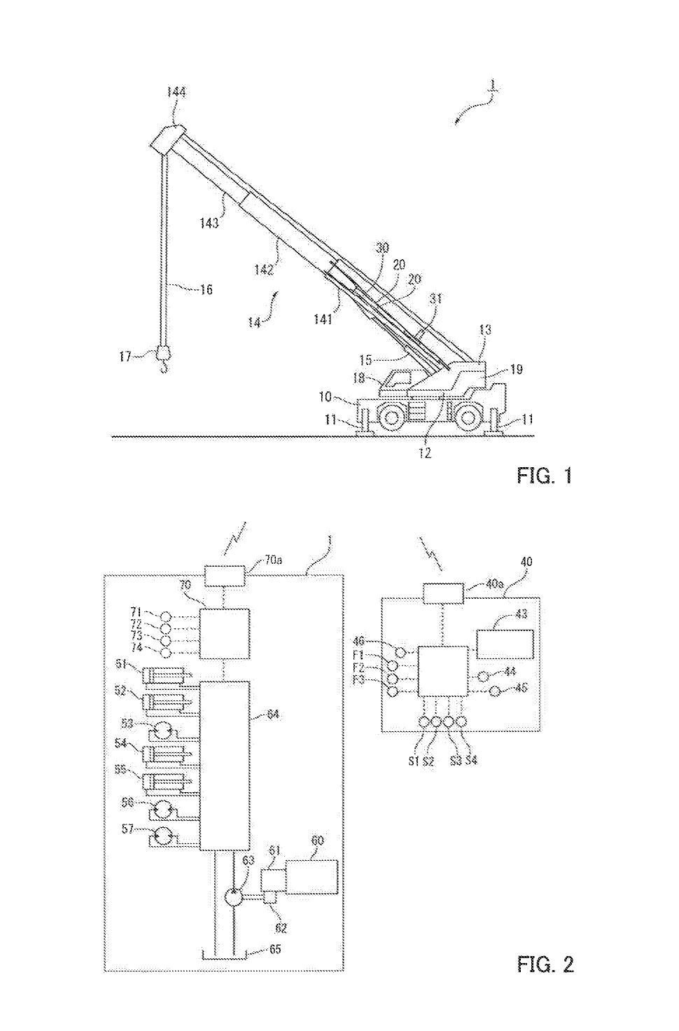

First, the overall configuration of rough terrain crane 1, as a mobile crane having remote control apparatus 40 for actuators, of the present embodiment will be described with use of FIG. 1. While description is given with use of rough terrain crane 1 as an example in the present embodiment, the present invention is not limited to this. The present invention is widely applicable to mobile cranes such as an all-terrain crane.

(Overall Configuration of Crane)

As illustrated in FIG. 1, rough terrain crane 1 of the present embodiment includes vehicle body 10, outrigger 11, slewing base 12, and boom 14. Vehicle body 10 serves as the main body part of a vehicle having a traveling function. Outrigger 11 is provided to each of the four corners of vehicle body 10. Slewing base 12 is mounted on vehicle body 10 in a horizontally slewable manner. Boom 14 is mounted on bracket 13 erected on slewing base 12.

Outrigger 11 is able to be slide-extending or slide-housing outward in the width direction from vehicle body 10 by extending or contracting slide cylinder 52. The outrigger is also able to be jack-extending or jack-housing in the vertical direction from vehicle body 10 by extending or contracting jack cylinder 51.

Slewing base 12 has a pinion gear to which the power of the slewing motor is transmitted. Slewing base 12 turns about the pivot shaft when the pinion gear engages with a circular gear provided to vehicle body 10. Slewing base 12 includes operator's cab 18, bracket 13, and counter weight 19. Operator's cab 18 is disposed on the front right side of slewing base 12. Bracket 13 is disposed on the back center of slewing base 12. Counter weight 19 is disposed on the back lower part of slewing base 12.

Boom 14 is composed of base end boom 141, intermediate boom 142, and top boom 143 in a telescopic manner. Boom 14 is extended or contracted by a telescopic cylinder disposed inside. The boom head at the tip of top boom 143 is provided with a sheave. The sheave is wound with wire rope 16. From wire rope 16, hook block 17 is suspended.

Outermost base end boom 141 is configured such that the base portion thereof is attached turnably to the support shaft horizontally disposed on bracket 13. Base end boom 141 derricks vertically with the support shaft being the center of rotation. Further, derricking cylinder 15 is stretched between bracket 13 and a lower face of base end boom 141. Boom 14 entirely derricks when derricking cylinder 15 is extended or contracted.

Further, in rough terrain crane 1 of the present embodiment, jib 30 and tension rods 20, 20 are housed in a laterally held state on a side face of base end boom 141. Jib 30 and tension rods 20, 20 are attached/housed with use of a plurality of pins (not illustrated) and side up cylinder 31.

(Configuration of Control System)

Next, a configuration of a control system including remote control apparatus 40 of the present embodiment will be described with use of FIG. 2. The control system of the present embodiment includes, as actuators, four jack cylinders 51, four slide cylinders 52, slewing motor 53, derricking cylinder 54, telescopic cylinder 55, main winch motor 56, and sub winch motor 57. These actuators are controlled by control valve 64 described below.

The control system of the present embodiment includes, as a hydraulic circuit, PTO 62, hydraulic pump 63, and control valve 64. PTO 62 takes out power from transmission 61 of engine 60. Hydraulic pump 63 is rotationally driven by PTO 62 and pressurizes hydraulic oil from oil tank 65. Control valve 64 controls the flow of hydraulic oil discharged from hydraulic pump 63. Control valve 64 is composed of a group of valves corresponding to respective actuators. Each valve is controlled by controller 70.

Controller 70 is a computer having a bus, an arithmetic unit, a memory unit, and the like. Controller 70 receives operation signals from slewing lever 71, derricking lever 72, telescoping lever 73, main winch lever 74, and the like. Controller 70 also receives operation signals from remote control apparatus 40 via communication section 70a. Based on a received operation signal, controller 70 computes a moving direction and a moving amount of each valve, transmits a signal to control valve 64, to thereby control the actuator.

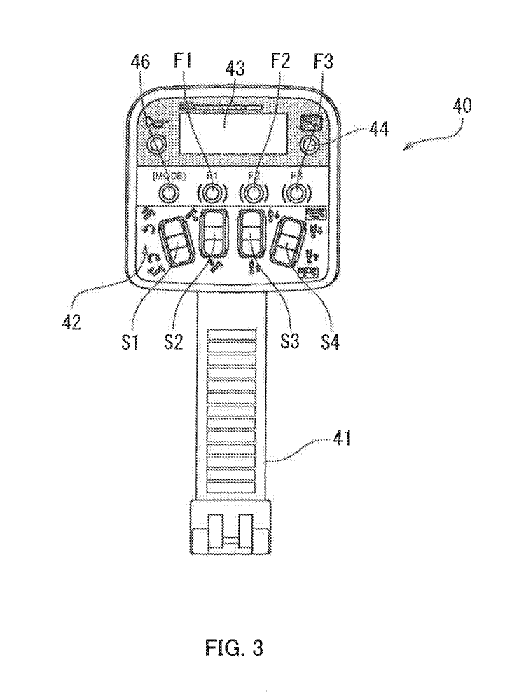

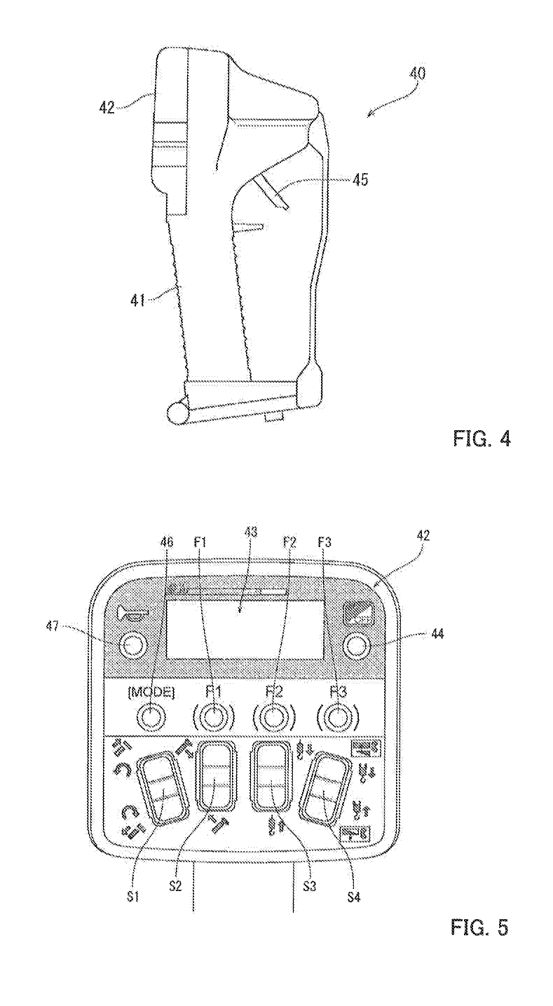

As illustrated in FIGS. 3 to 5, remote control apparatus 40 includes operation surface 42 for operating the actuators, and grip 41, extending downward from operation surface 42, to be gripped by a hand. Remote control apparatus 40 also has communication section 40a. With operation performed on lever switches S1 to S4 and setting buttons F1 to F3 described below, communication section 40a gives an instruction to controller 70 via communication section 70a of controller 70 and acquires information from controller 70. Remote control apparatus 40 has, on the rear face side of grip 41, trigger 45 to be operated with a forefinger in a state where grip 41 is being held. As described below, trigger 45 drives an actuator, selected by the selection section, at a velocity corresponding to the operation amount in the selected direction (forward direction or backward direction). This means that when trigger 45 is pulled back largely, an actuator is driven fast, while when it is pulled back slightly, an actuator is driven slowly. Trigger 45 is able to operate a plurality of actuators. However, as only one trigger 45 is provided, it is impossible to apply different operation amount to each actuator.

Operation surface 42 includes display section 43, power switch 44, mode button 46, setting buttons F1, F2, and F3, slewing lever switch S1, derricking lever switch S2, sub winch lever switch S3, and main winch lever switch S4. Display section 43 is disposed in an upper portion of operation surface 42. Power switch 44 is disposed on the right side of display section 43. Mode button 46 is disposed on the bottom left side of the display section. Setting buttons F1, F2, and F3 are disposed to be aligned on the right side of mode button 46. Slewing lever switch S1 is disposed below operation surface 42 corresponding to mode button 46 and setting buttons F1, F2, and F3. Mode button 46 and setting buttons F1 to F3 constitute a mode switching section.

Display section 43 is a liquid crystal display, and is switched to a setting screen when mode button 46 is long-pressed. Subsequent to mode button 46, when setting buttons F1, F2, and F3 each are pressed, the mode is switched to a crane mode (planking suspending step mode), an outrigger extending/housing step mode, and a jib mounting/dismounting step mode.

Four lever switches S1 to S4 as selection sections each set the motion direction of each actuator to a forward direction or a backward direction when each switch is moved (tilted) from the neutral position to a first direction or a second direction. Each lever switch S1 (S2, S3, S4) is energized by a spring so as to return to the neutral position from the moved (tilted) position.

Specifically, regarding slewing lever switch S1, in the crane mode, when slewing lever switch S1 is tilted upward, a left turn is selected, while when it is tilted downward, a right turn is selected. In the jib mounting/dismounting step mode, when slewing lever switch S1 is tilted upward, a boom 14 extending motion is selected, while when it is tilted downward, a boom 14 contracting motion is selected. Further, in the outrigger extending/housing mode, slewing lever switch S1 corresponds to the operation of outrigger 11 on the back left side.

Regarding derricking lever switch S2, in the crane mode, when derricking lever switch S2 is tilted upward, a boom 14 derricking motion is selected, while when it is tilted downward, a boom 14 falling motion is selected. In the jib mounting/dismounting step mode, when derricking lever switch S2 is tilted upward, a derricking motion of boom 14 or jib 30 is selected, while when it is tilted downward, a falling motion of boom 14 or jib 30 is selected. In the jib mounting/dismounting step mode, when setting button F1 is pressed, the operation targets, namely boom 14 and jib 30, are switched from each other. Further, in the outrigger extending/housing mode, derricking lever switch S2 corresponds to the operation of outrigger 11 on the front left side.

Regarding sub winch lever switch S3, in both the crane mode and the jib mounting/dismounting step mode, when sub winch lever switch S3 is tilted upward, lowering of the sub winch is selected, while when it is tilted downward, hoisting of the sub winch is selected. Further, in the outrigger extending/housing mode, sub winch lever switch S3 corresponds to the operation of outrigger 11 on the front right side.

Regarding main winch lever switch S4, in the crane mode, when main winch lever switch S4 is tilted upward, lowering of the main winch is selected, while when it is tilted downward, hoisting of the main winch is selected. In the jib mounting/dismounting step mode, when main winch lever switch S4 is tilted upward, hoisting of the main winch or up-mode of side up cylinder 31 is selected, while when it is tilted downward, lowering of the main winch or down-mode of side up cylinder 31 is selected. In the jib mounting/dismounting step mode, when setting button F3 is pressed, the operating targets, namely the main winch and side up cylinder 31, are switched from each other. Further, in the outrigger extending/housing mode, main winch lever switch S4 corresponds to the operation of outrigger 11 on the back right side.

(Action)

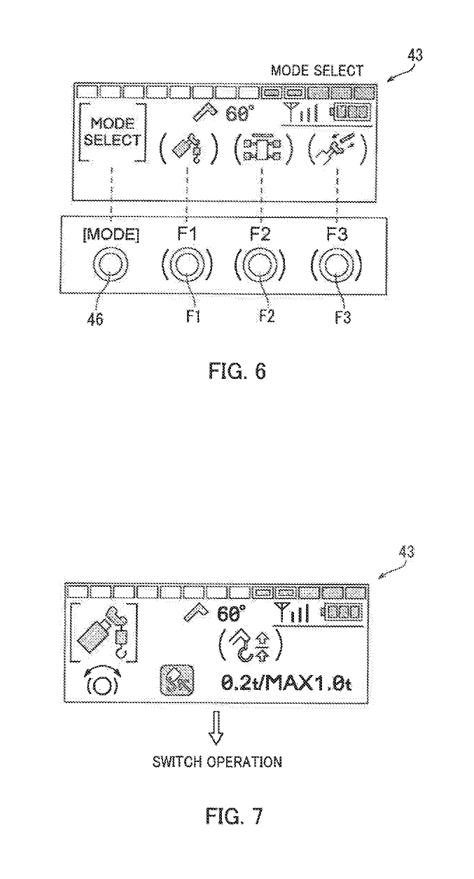

Next, an action of remote control apparatus 40 for the actuators of rough terrain crane 1 according to the present embodiment will be described with reference to FIGS. 6 to 10B. First, on the mode select screen (initial screen) of FIG. 6, subsequent to mode button 46, when setting button F1 is pressed corresponding to an icon of display section 43, the crane mode (planking suspending step mode) is set, when setting button F2 is pressed, the outrigger extending/housing step mode is set, and when setting button F3 is pressed, the jib mounting/dismounting step mode is set. In this way, the mode switching section requires two-step operation using two types of buttons such as mode button 46 and setting button F1 to F3. This configuration contributes to prevention of misoperation of mode switching.

(Crane Mode)

As illustrated in FIG. 7, in the crane mode (planking suspending step mode), it is displayed that the mode is a crane mode with an icon on the left side in the display section 43. In addition, slewing brake ON alert, a hook-in capable icon, and overwinding release icon are displayed. In the crane mode, when setting button F2 is pressed, overwinding is released. Then, in the planking suspending step, single operator operates remote control apparatus 40. Specifically, an operator drives slewing motor 53, derricking cylinder 54, sub winch motor 57, and main winch motor 56 by using slewing lever switch S1, derricking lever switch S2, sub winch lever switch S3, and main winch lever switch S4. Thereby, the operator operates boom 14 and the winch to thereby set the planking at a predetermined position corresponding to each outrigger 11. In the planking suspending step, there is often no assistant worker such as a worker for slinging, different from a hosting work. In that case, the operator goes out of operator's cab 18 and manually slings planking. As such, in order to set planking at a predetermined position, after the operator returns to operator's cab 18, the operator must go out and manually perform a slinging the planking, conventionally. Therefore, the operation efficiency is poor. Meanwhile, when remote control apparatus 40 is used, an operator is able to operate boom 14 and winches while being located near the planking. Therefore, it is not necessary to go up and down operator's cab 18 only for operation.

(Jib Mounting/Dismounting Step Mode)

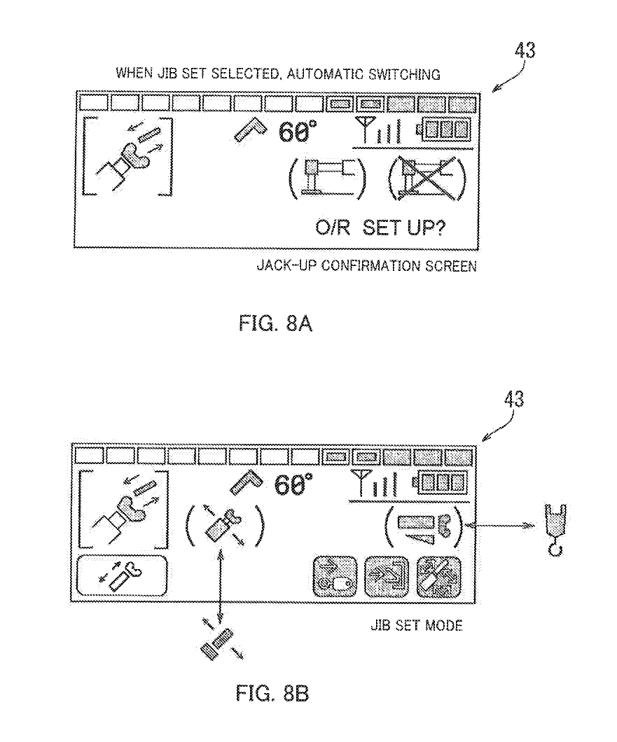

In the jib mounting/dismounting step mode, first, a jack-up confirmation screen is displayed as illustrated in FIG. 8A. In the jack-up confirmation screen, when jack-up is completed, setting button F2 is pressed to proceed to a jib mounting/dismounting screen. On the other hand, when jack-up is not completed, setting button F3 is pressed to return to the mode select screen. Then, in the jib mounting/dismounting step, as illustrated in FIG. 8B, telescopic cylinder 55, derricking cylinder 54 (or jib tilt cylinder), sub winch motor 57, and main winch motor 56 (or side up cylinder 31) are driven with use of slewing lever switch S1, derricking lever switch S2, sub winch lever switch S3, and main winch lever switch S4. In this way, an operator operates boom 14 and jib 30 to thereby mount jib 30 on the tip of boom 14 or remove it. Further, by pressing setting button F1, it is possible to switch the motion of the actuator corresponding to derricking lever switch S2 to boom derricking or jib tilting. Further, by pressing setting button F3, it is possible to switch the motion of the actuator corresponding to main winch lever switch S4 to main winch or side up/down. The procedures of the jib mounting/dismounting step are complicated, so it is difficult for a worker who is not used to a mounting/dismounting work. As such, the operator of the crane must come out from operator's cab 18 to prepare for it. In that case, as it takes time to go up and down operator's cab 18 in rough terrain crane 1 or an all-terrain crane, work efficiency is poor. Accordingly, by using remote control apparatus 40, the operator is able to operate boom 14, sub winch (not illustrated), side up cylinder 31, and the like while being located near jib 30. Therefore, the operator does not need to go up and down operator's cab 18, whereby work efficiency is improved.

Here, jib mounting/dismounting procedures will be described in brief to facilitate understanding. First, at the time of jib mounting, jib 30 is moved from the housed state to the lower surface of boom 14. In this state, tension rod 20 is connected to the link at the tip of boom 14, and a jib set pin is inserted. Then, an auxiliary rope is attached to prepare for shaking out jib 30 from boom 14. Then, jib 30 is shaken out from boom 14, and the jib tilt cylinder is extended to wing up jib 30 to an operation state. Meanwhile, at the time of jib housing, the jib tilt cylinder is entirely contracted to allow jib 30 to be in a suspended state. In this state, an auxiliary rope is attached to prepare for fixing jib 30 to boom 14. Next, jib 30 is drawn to the lower surface of boom 14 and fixed to boom 14. Next, the jib set pin is drawn to detach tension rod 20 from the link at the tip of boom 14. Then, jib 30 is drawn from the lower face to a side face of boom 14.

In the jib mounting described above, a manual work, derricking of boom 14, and hoisting/lowering of sub winch are performed. For example, in the procedure of shaking out jib 30 from boom 14, trigger 45 is pulled by a forefinger while derricking lever switch S2 is tilted downward by a thumb to thereby raise boom 14. Next, one end of an auxiliary rope is manually inserted into the tip of jib 30 and is engaged at a position near the base end of boom 14. Then, the other end of the auxiliary rope is manually attached to an auxiliary hook. In this state, the sub winch is hoisted by pulling trigger 45 by a forefinger while tilting sub winch lever S3 downward by a thumb to a degree of not stretching the auxiliary rope too much. Next, the safety rope is manually removed from the tip of jib 30. In this state, by pulling trigger 45 by the forefinger while tilting derricking lever switch S2 downward by the thumb, boom 14 is further raised. Then, in a state where boom 14 is slightly extended, the sub winch is lowered to allow jib 30 to be vertical to the ground. Further, while lowering the sub winch, boom 14 is tilted and the auxiliary rope is manually removed. At this time, trigger 45 is pulled by the forefinger, while both the derricking lever switch S2 and the sub winch lever switch S3 are tilted by the thumb. The work further continues thereafter.

(Outrigger Extending/Housing Step Mode)

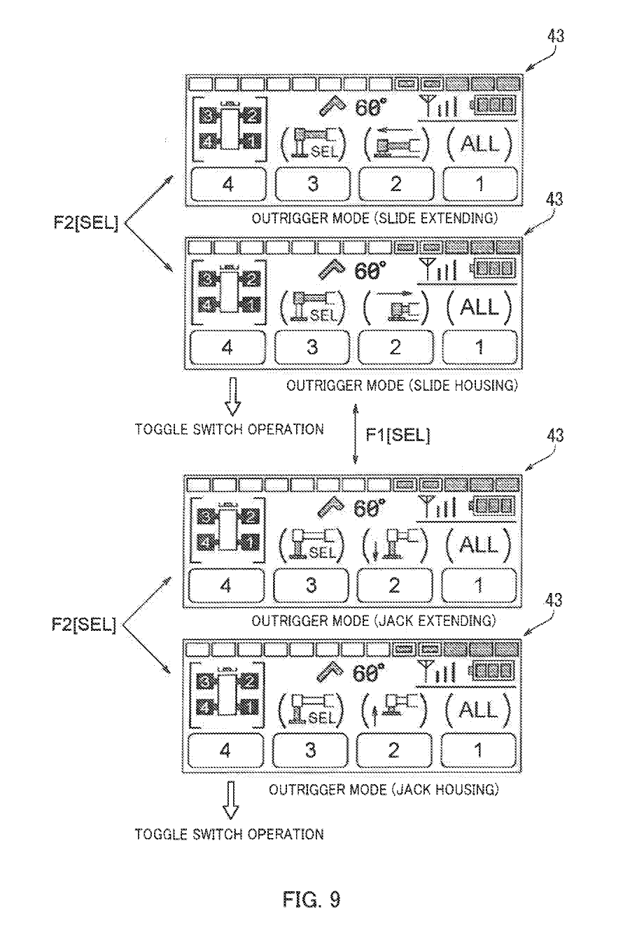

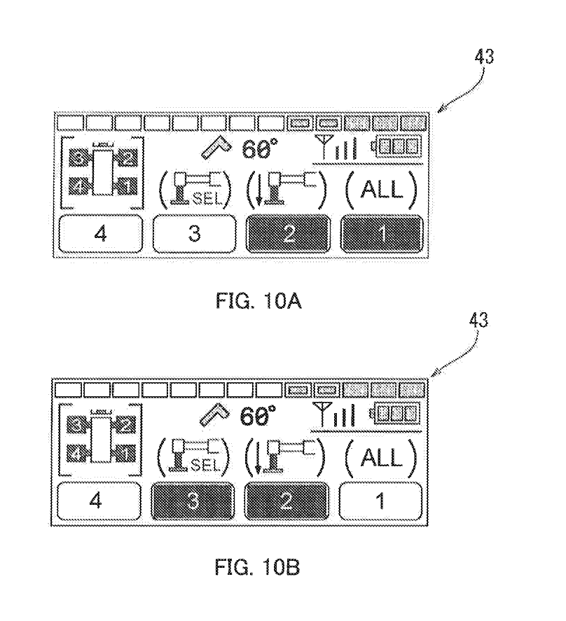

As illustrated in FIG. 9, in the outrigger extending/housing step mode, it is displayed that the mode is outrigger extending/housing step mode, with an icon at the left in the display section 43. Meanwhile, at the right in the display section 43, a selected step among the four steps described below is displayed. Then, when setting button F1 is pressed, a slide extending/housing screen and a jack extending/housing screen are switched from each other. On the slide extending/housing screen, when setting button F2 is pressed, slide extending and slide housing are switched from each other. On the jack extending/housing screen, when setting button F2 is pressed, jack extending and jack housing are switched from each other. Then, by pulling trigger 45 by a forefinger while tilting switches S to S4 corresponding to four outriggers 11 by a thumb, respective outriggers 11 are operated. In the jack extending procedure, in the case of using outriggers 11 on the right side in a narrow place, for example, by tilting two right-side lever switches S3 and S4 simultaneously by a thumb as illustrated in FIG. 10A, front right outrigger 11 and back right outrigger 11 can be extended. Similarly, in the case of extending or contracting only front outriggers 11, by tilting two lever switches S2 and S3 in the middle simultaneously by a thumb as illustrated in FIG. 10B, front right outrigger 11 and front left outrigger 11 can be extended or contracted.

(Effect)

Next, advantageous effects to be achieved by remote control apparatus 40 of the actuator of the present embodiment will be listed and described.

(1) As described above, remote control apparatus 40 for the actuators of the mobile crane of the present embodiment includes an apparatus body having grip 41 to be gripped by a hand and operation surface 42 for operating the actuators; lever switches S1 to S4 as selection sections for selecting the actuators, the switches each being disposed on operation surface 42 and setting the motion direction of the selected actuator to be a forward direction or a backward direction according to a movement of the switch from a neutral position to a first direction or a second direction; and trigger 45 disposed near grip 41 and allowing the actuator selected by each of lever switches S1 to S4 to operate in a forward direction or a backward direction at a velocity corresponding to the operation amount. In remote control apparatus 40, configured as described above, of the present embodiment, two lever switches S2 and S3 that are most frequently used actuators in the work preparation step of the mobile crane, among lever switches S1 to S4, are arranged adjacently near the center of operation surface 42. Accordingly, in remote control apparatus 40 of the present embodiment, it is easy to operate lever switches S2 and S3 that are frequently used in the work preparation step by a thumb in a state where remote control apparatus 40 is held by one hand.

In the work preparation step, an operator must go out of operator's cab 18 and perform preparation manually. Conventionally immediately after returning to operator's cab 18 for operating an actuator, the operator must go out again and perform preparation manually. Therefore, work efficiency is poor. Meanwhile, in the case of remote control apparatus 40 of the present embodiment, the operator is able to operate an actuator outside operator's cab 18. As such, the operator does not need to go up and down operator's cab 18 only for operation. Further, two lever switches S2 and S2 corresponding to frequently used actuators are arranged near the center. As such, it is possible to operate remote control apparatus 40 for operating the actuator by a thumb of one hand, and perform a work by the other hand. Further, by simultaneously operating two lever switches S2 and S3, it is possible to operate two actuators simultaneously.

(2) Further, derricking lever switch S2 and sub winch lever switch S3 that are most frequently used in the work preparation step of a mobile crane, in particular, in a planking suspending step and a jib mounting/dismounting step, are disposed adjacently near the center of the operation surface 42. Accordingly, the work preparation step can be performed efficiently. This means that in the jib mounting/dismounting step for example, when jib 30 is shaken out or drawn to boom 14, derricking of boom 14 and hoisting or lowering of the sub winch are often performed. As lever switches S2 and S3 corresponding to them are disposed near the center, operation can be made easily. Further, in the procedure of shaking out jib 30, a work to tilt boom 14 and lower the winch simultaneously can be realized.

(3) Further, remote control apparatus 40 of the present embodiment has four lever switches S1 to S4. Four lever switches S1 to S4 are slewing lever switch S1, derricking lever switch S2, sub winch (auxiliary) lever switch S3, and main winch (main) lever switch S4 provided in the order presented from the left of the operation surface 42. This layout is almost the same as the lever layout in operator's cab 18 (in the order of slewing, derricking, telescope, sub winch, and main winch). Accordingly, an operator can memorize the layout easily, whereby misoperation can be prevented.

(4) Further, the remote control apparatus 40 further includes a mode switching section that switches actuators assigned to the selection sections. The mode switching section is composed of setting buttons F1 to F3 corresponding to the respective modes, and a mode button 46 enabling mode switching by setting buttons F1 to F3. Among them, setting buttons F1 to F3 are composed of setting button F1 corresponding to a planking suspending step mode of the mobile crane, setting button F3 corresponding to a jib mounting/dismounting step mode, and setting button F2 corresponding to an outrigger extending/housing step mode. By switching the mode as described above, it is possible to remotely control a large number of actuators by a limited number of operation sections. It should be noted that while description has been given on the case where switching can be made to any of the three modes in the present embodiment, the present invention is not limited to this. The case where at least two modes are switchable is acceptable.

In addition, in remote control apparatus 40, one lever switch can be used for two actuators through switching in each preparation step. For example, in the jib mounting/dismounting step mode, when setting button F1 is pressed, derricking switch S2 is switched to boom derricking or jib tilt. Further, extending/housing of side up cylinder 31 is switched to the main winch that is less frequently used in the jib mounting/dismounting step mode. Further, setting buttons F1 and F3 are disposed coaxially on the lever switches S2 and S4 to be switched. Such an arrangement contributes to prevention of misoperation by unifying the recognition of the operator.

(5) Further, remote control apparatus 40 includes four lever switches S1 to S4. In the outrigger extending/housing step mode, four lever switches S1 to S4 are assigned back left outrigger lever switch S1, front left outrigger lever switch S2, front right outrigger lever switch S3, and back right outrigger lever switch S4 in the order presented from the left of the operation surface 42. Accordingly, it is possible to simultaneously operate only two outriggers 11 on the front side, only two outriggers 11 on the right side, or only two outriggers 11 on the left side.

While the embodiment of the present invention has been described in detail with reference to the accompanying drawings, a specific configuration is not limited to the embodiment. Design changes of a degree not deviating from the scope of the present invention are included in the present invention.

For example, in the present embodiment, description has been given on the case including a crane mode, a jib mounting/dismounting step mode, and an outrigger extending/housing step mode. However, the present invention is not limited to this. A configuration in which only two modes, that is, crane mode and a jib mounting/dismounting step mode, are switched from each other is also acceptable.

### REFERENCE SIGNS LIST

1 Rough terrain crane (mobile crane)
10 Vehicle body
11 Outrigger
12 Slewing base
14 Boom
15 Derricking cylinder
30 Jib
20 Tension rod
31 Side up cylinder
40 Remote control apparatus
41 Grip
42 Operation surface
43 Display section
45 Trigger
46 Mode button
F1-F3 Button
S1 Slewing lever switch
S2 Derricking lever switch
S3 Telescoping lever switch
S4 Main winch lever switch;
51 Jack cylinder
52 Slide cylinder
53 Slewing motor
54 Derricking cylinder
55 Telescopic cylinder
56 Main winch motor
57 Sub winch motor
71 Slewing lever
72 Derricking lever
73 Telescoping lever
74 Main winch lever

1. A remote control apparatus for an actuator of a mobile crane, the apparatus comprising:
an apparatus body having a grip to be gripped by a hand and an operation surface for operating the actuator;
a plurality of selection sections for selecting the actuator, the selection sections each being disposed on the operation surface, the selection sections each setting a motion direction of the selected actuator to be a forward direction or a backward direction according to a movement of the selection section from a neutral position to a first direction or a second direction; and
a trigger section disposed near the grip, the trigger section allowing the actuator selected by the selection section to operate in the forward direction or the backward direction according to an operation amount, wherein
among the selection sections, two selection sections that are most frequently used in a work preparation step of the mobile crane are disposed adjacently near center of the operation surface.

2. The remote control apparatus according to claim 1, wherein
a derricking lever switch and an auxiliary lever switch that are used most frequently in the work preparation step of the mobile crane are disposed adjacently near the center of the operation surface.

3. The remote control apparatus according to claim 2, wherein
the number of the selection sections is four, and
the four selection sections are a slewing lever switch, a derricking lever switch, an auxiliary lever switch, and a main lever switch that are provided in order presented from left of the operation surface.

4. The remote control apparatus according to claim 1, further comprising
a mode switching section that switches actuators assigned to the selection sections, wherein
the mode switching section includes a plurality of setting buttons corresponding to respective modes, and a mode button that enables mode switching by the setting buttons, and
the setting buttons correspond to at least two modes among three modes including a planking suspending step mode, a jib mounting and dismounting step mode, and an outrigger extending and housing step mode, of the mobile crane.

5. The remote control apparatus according to claim 4, wherein
the number of the selection sections is four, and
in the outrigger extending and housing step mode, the four selection sections are assigned a back left outrigger lever switch, a front left outrigger lever switch, a front right outrigger lever switch, and a back right outrigger lever switch, in order presented from left of the operation surface.
